(19) United States
(12) Patent Application Publication
(10) Pub. No.: US 2007/0218873 A1
(43) Pub. Date: Sep. 20, 2007

(54) Mobile Telephone Camara System

(76) Inventor: Easa Taheri Oskouei, Sheffield (GB)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/577,433

(22) PCT Filed: Oct. 24, 2005
(86) PCT No.: PCT/GB05/04080

§ 371 Date: Apr. 18, 2007

(30) Foreign Application Priority Data
Oct. 22, 2004 (GB) 0423407.6
Nov. 11, 2004 (GB) 0424932.2

(51) Int. Cl. H04N 7/00

(52) U.S. Cl. 455/410

(57) ABSTRACT

A system including a first device comprising a first radio communications unit, a video camera, and electronic computer means, and a second device comprising a second radio communications unit, video display means and electronic computer means, wherein the first device is adapted, upon receipt of a predetermined communication from the second device, to activate the video camera and to transmit live video data from the video camera to the second radio communications device, and wherein the second radio communications device is adapted to display the live video data on the video display means.

### BACKGROUND

The present invention relates to a system in which a first mobile telephone handset (the “originator” handset) is used to check an environment at which a second mobile telephone-enabled unit or handset is located, by dialing the second unit or handset from the originator handset.

Video and camera mobile telephones are well known, as is the use of one telephone to take a photograph or record a video clip before sending this as a data file to a second telephone. These existing systems have the disadvantage that there are no means for preventing unauthorised access to the data captured by the first telephone.

However, the present applicant is not aware of systems that allow a second unit or handset to be called from a first, originator handset, and to be activated so as to stream live video or other data from the second unit or handset to the first, with security means for preventing unauthorised access to each individual or all handsets.

### BRIEF SUMMARY OF THE DISCLOSURE

According to a first aspect of the present invention, there is provided a device comprising a radio communications unit, a video camera, and electronic computer means, wherein the device is adapted, upon receipt of a predetermined communication from a remote radio communications unit, to activate the video camera and to transmit live video data from the video camera to the remote radio communications unit.

According to a second aspect of the present invention, there is provided a system including a first device comprising a first radio communications unit, a video camera, and electronic computer means, and a second device comprising a second radio communications unit, video display means and electronic computer means, wherein the first device is adapted, upon receipt of a predetermined communication from the second device, to activate the video camera and to transmit live video data from the video camera to the second radio communications device, and wherein the second radio communications device is adapted to display the live video data on the video display means.

Preferably, the (first) device further comprises microphone means and is adapted to transmit sound picked up by the microwave means to the remote (second) radio communications unit together with the live video data.

The live video data may be transmitted as streaming data.

The radio communications units may each comprise a unit adapted for standard mobile telephone transmissions, for example operating under the GSM or 3G protocol.

The remote radio communications unit may comprise a standard mobile telephone adapted to receive and display video data, and optionally also sound data.

The (first) device may also comprise a standard mobile telephone equipped with a video camera, optional microphone and electronic computer means adapted to check the predetermined communication for authenticity.

The predetermined communication preferably includes a caller identity (e.g. mobile telephone number or any other network type addresses like IP. address etc.) of the remote radio communications unit, and also a security code such as a numeric, alphabetical or alphanumeric PIN code.

The electronic computer means of the device is preferably adapted, for example by way of stored computer program means, to activate the video camera and to transmit video data only when the caller identity and the security code has been checked and found to be valid or authorised.

The (first) device is preferably made resistant to tampering by requiring input of a security code in order to be deactivated.

The (first) device may also be configured so as to contact the (remote) second device of its own accord without being first contacted by the (remote) second device. No security code is required when the (first) device contacts the (remote) second device, since the (first) device will already be programmed with the telephone number of the (remote) second device.

More than one (remote) second device may be provided for accessing video data via the (first) device. Each (remote) second device needs to be registered or assigned to the (first) device so as to ensure security and prevent unauthorised access. One (remote) second device may be configured as a “master” device and registered or assigned to the (first) device by way of any appropriate protocol, including Bluetooth®. The “master” device can then also be used to configure one or more “secondary” remote devices, or these can be directly registered with the (first) device.

Instead of the electronic computer means of the (first) device directly authenticating the caller identity and/or security code, the authentication process may be performed by a remote server, for example by way of a SIP (server identification protocol) architecture.

In this way, a remote authentication server may be operated by an operator and a charge made for authentication, this charge being separate from any communications charge that may be levied by a network operator that provides the infrastructure enabling radio communication between the devices.

In the following description, the term “Originator” refers to the second or remote radio communications device or unit, and the term “BiB” refers to the first device.

When the ‘Originator’ phone dials the ‘BiB’ phone, the ‘BiB’ phone would not necessarily need to ring, but when receiving a call from the ‘Originator’, it will wait for a security code, (e.g. a four digit PIN code) which is automatically requested from the ‘Originator’.

This request can be automatically handled by software installed in the BiB handset by way of several different methods:
1. The pass-code is requested by the software installed on the Originator's handset, before any connection is made to the BiB handset. If the code input in the Originator handset is not correct, the connection to the BiB handset is not made. When a correct code is input and sent by the Originator's handset, this is again checked within the BiB handset to ensure the originator's ID and the pass-code are registered in the software installed in the BiB handset. If they match, then the connection is made, with either the BiB permitting the data transmission to the Originator handset based on the connection request from the originator, or the BiB contacting the Originator handset automatically for making the connection. This technique may be implemented using SMS (Short Message Service) protocols.
2. SIP (Session Identification Protocol): by referring to FIG. 8, when the Originator handset is dialing to BiB (1), it actually connects to a remote server at the same time (2), while its connection to the BiB is awaiting approval from the server. The remote server checks the BiB number that the Originator is trying to connect. The server then either requests the BiB to confirm its acceptance for this request (based on originator's ID or phone number) (3). The server may instead check to see if the Originator is allowed to connect to such a BiB within its own database. If it is allowed (4), the server then requests a Pin code from the Originator (5) if required. Upon authenticating the Originators ID (or phone number) and/or the Pin code (2, 3, 4 & 5 again), the software within the BiB handset accepts the call from the Originator and connection is made (6). This is called SIP technique. The communication network for 3G or video call etc. is located on line (1) and (6).
3. Instead of using SMS to activate the remote BiB handset, based on FIG. 9 the data within the phone connection signal on a 3G network or any other network is analysed in the BiB or the Originator handset. This is all possible on existing communication networks and no extra network is required (as explained in SIP). This method is a simple replacement for SMS technique but is more reliable and faster.

Otherwise, if the Originator's ID is not recognised or the pass-code did not match, after a few failed attempts, it may automatically disconnect and as a result that Originator's phone number will not be able to connect to that ‘BiB’ phone. This connection can be reset within the ‘BiB’ phone or the system provider only later on.

After connecting to the ‘BiB’ phone, the ‘Originator’ can listen to and/or view the environment around the ‘BiB’ phone. This is dependent as to whether the ‘BiB’ phone is fitted with a camera. This system is to enable the monitoring of a remote location where the ‘BiB’ phone is located. If the BiB phone is set up to access calls from un-registered originator handsets, this connection can be made from any ‘Originator’ phone with or without sending a correct security code.

Embodiments of the present invention may have systems concerning the responding method to the ‘Originator’ phone within the ‘BiB’ phone, and also concerning the automatic connection within the ‘BiB’ phone that is controlled after recognising the correct security code.

The methodology is to prevent hackers from accessing the ‘BiB’ phone and is not only based on the number of occasions of inputting incorrect security codes by the ‘Originator’, but also by defining the permitted originators' phone numbers within the BiB phone. Therefore any other phone that tries to connect to the ‘BiB’ phone, will be rejected as its ID is not defined as recognisable by the ‘BiB’ phone within its software.

Facilities may be provided within the ‘BiB’ phone to define new numbers or delete the previous numbers as the ‘Originator’ for that BiB, in a safe manner.

The ‘BiB’ phone system is fully portable and can be used within areas such as industries, childcare, hospitals, teaching institutes, laboratories, etc. as explained.

In terms of security, important features of embodiments of the present invention may include:
1) If the master Originator phone is used by an unauthorized person, they cannot access the BiB as they do not know the PIN or pass code for that personal BiB.
2) If the master Originator phone is used by an unauthorized person, they cannot define another Originator Access phone to that BiB as it will request the PIN or pass code for the master phone for setting up an extra access phone to the BiB. Since the PIN or pass code is not available, the setup cannot be completed. Furthermore, the BiB handset may also be required to confirm registering a new access phone.
3) If the BiB is taken by an unauthorised person, it cannot be used for access thereto or to set up a new access phone as explained in 2) above. Therefore stolen BiBs will be of no use.
4) The BiB handset can automatically can go into BiB mode (software is activated) when the hand-set is switched on (this is an option available in BiB software). If the user wishes to exit this software, he has to enter a PIN or pass code to be able to terminate this software, which in some cases will allow the use of other applications on the BiB handset, like using it as a normal mobile phone etc.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

### BRIEF DESCRIPTION OF THE DRAWINGS

For a better understanding of the present invention and to show how it may be carried into effect, reference shall now be made to the accompanying drawings, in which:

FIG. 1 shows the general communication system between the Originator phone and the BiB.

FIG. 2 shows the connection method from the Originator phone to the BiB within the proposed system in relation to a Communication Management System for BiBs (CMS-BiB).

FIG. 3 shows a general way of checking the BiB's access rights.

FIG. 4 is a sequence diagram showing how a master originator can be registered with a BiB handset using SMS technique.

FIG. 5 is a sequence diagram showing how a BiB can decline a registration request from an unauthorised master originator using SMS technique.

FIG. 6 is a sequence diagram showing how a BiB can decline access from a master originator when an incorrect PIN code is entered.

FIG. 7 is a sequence diagram showing how auxiliary originators can be registered with a BiB handset.

FIG. 8 is a sequence diagram on presenting a central server to control connections in between a BiB handset and an Originator handset.

FIG. 9 shows a sequence of authentication between BiB and Originator handsets based on direct data transfer into either handset, without relying on SMS.

### DETAILED DESCRIPTION

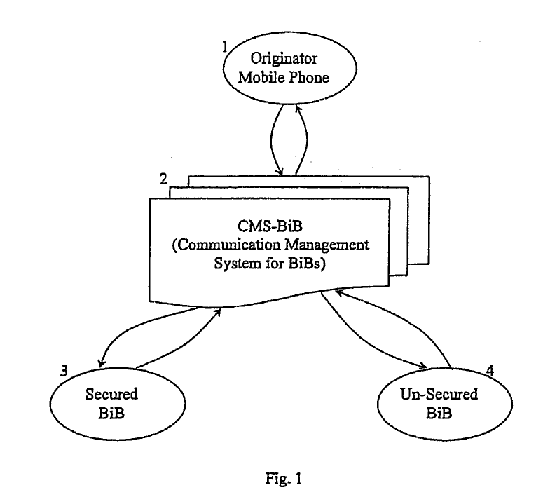

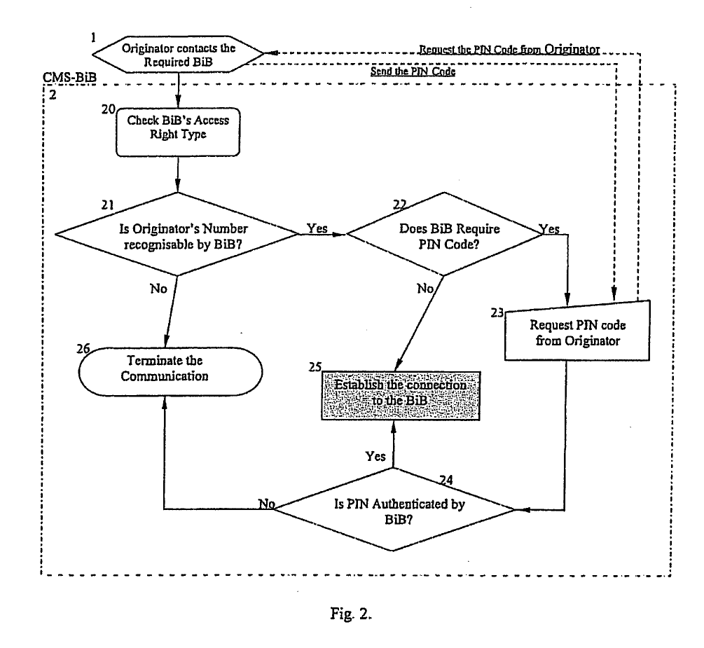

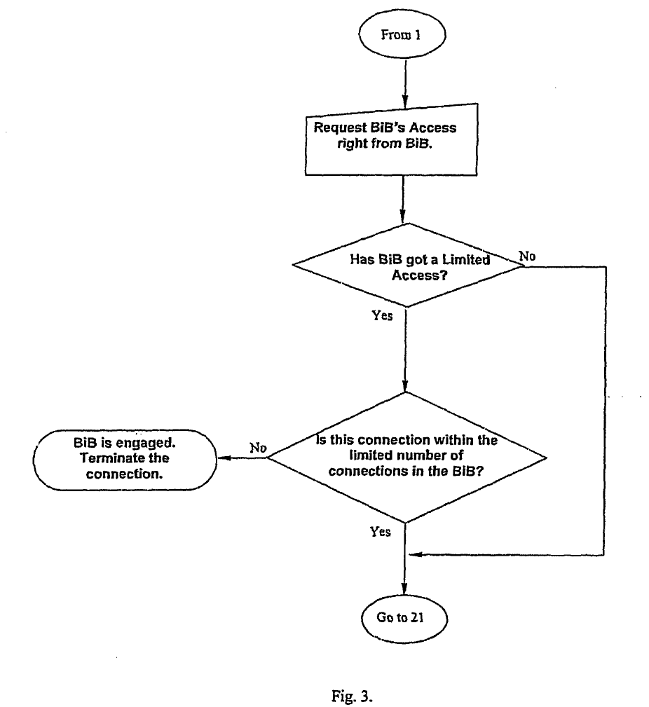

Embodiments of the present invention seek to enable the contacting of a BiB from any video-phone (this phone is referred to as the Originator), and to connect automatically by inputting a pass code. The BiB will allow the connection if the pass code is correct. This is shown as way of example within FIGS. 1 to 6.

A simple explanation is that the Originator is able to view and hear what is going on around the BiB, whilst the BiB is transferring the sound and/or images via the phone line to the Originator.

The consumer would buy a BiB separately and define its Originator's phone number and pass code within the BiB to be able to contact it at any time he wishes.

It will be possible to allow unlimited phone numbers to access one BiB, or alternatively to limit it to connect to only one or a limited number of specified phone numbers designated as the originator with or without a specific pass code or codes. Therefore BiBs can be classified into two main groups:
i. Limited access BiBs
ii. Un-Limited access BiBs.

Limited access BiB refer to a BiB when it is allowed only to connect to one or limited number of pre-registered originator handsets in a sequential order or parallel access/all at once. Unlimited access BiB refers to a BiB that allows as many originator handset to access it without any need to pre-register them within the BiB handset in advance. This access can again be in Sequential order or parallel access with or without an access Pin code.

Any BiBs within either of the groups explained above, can again be in one of the following two formats:
a) Secured BiBs
b) Unsecured BiBs

In secured BiBs, the originators' phone numbers are checked to see if the connections from these originators' mobile phones to this BiB are allowed or not. If the connection is allowed, then it can either connect by requesting a PIN code for the originator's phone number, and allow the connection after authenticating this phone number and PIN code, or allow the connection without any need for this PIN code.

In unsecured BiBs, as soon as. an originator contacts the BiB, the connection is established.

It is not necessary for the BiB to have any dialing tone, as it will be automatically connected when the Originator's phone number and PIN code are authenticated. Moreover, the BiB phone does not need to ring when it is called by the Originator phone.

The BiBs have a specific phone number, alternatively or in addition they may have a URL address to enable connection via the Internet. In addition to sending live video, it is possible to record the video clips within BiBs and send them to the originator, on request:
(i) Instantaneously, based on a request i.e. dialing from the Originator's phone to the BiB, or
(ii) At pre-set times, based on a timer setting within the BiB that sends the message to the specific Originator's phone.

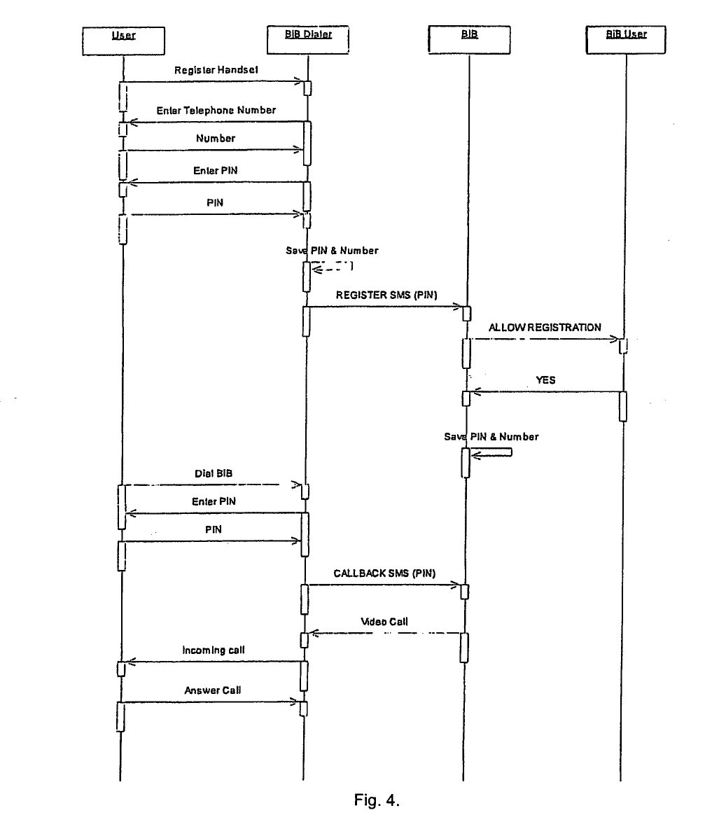

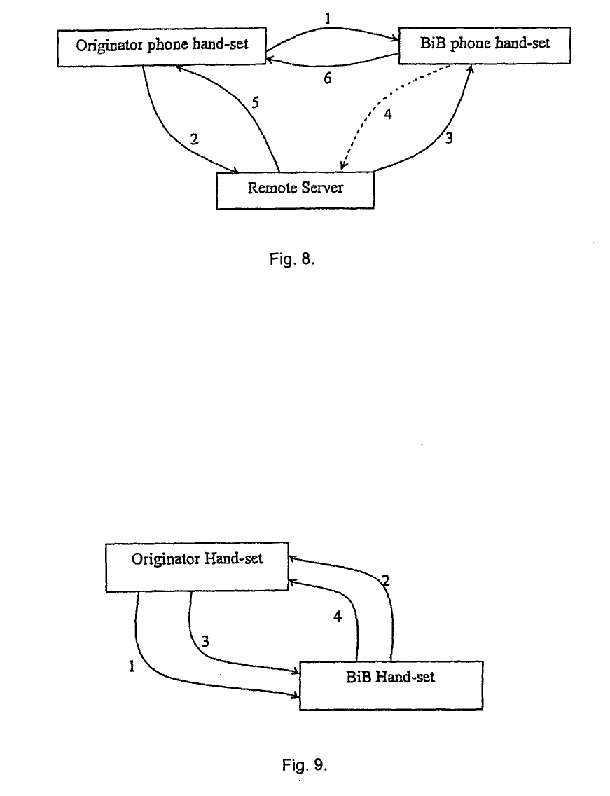

Referring now to FIG. 4, this is a sequence diagram showing how a master originator can be registered with a BiB handset. The BiB dialer component may form part of the BiB master software. During registration, this collects the PIN and telephone details for the registration message. It stores the PIN and telephone number locally for checking whenever the user wishes to dial the BiB. This can also be stored on a remote server as shown in FIG. 8. During dialing, it checks the PIN provided against the registered PIN and if correct, it sends an SMS message to the BiB to request connection or the server sends a data logger to the originator and the BiB to confirm authentication. This data logger may contain a key that is generated instantaneously and provided only for this connection. Therefore the BiB makes a video call to the Originator handset or the video call is made from the originator handset to the BiB. All SMS messages generated during the registration and authentication procedure are preferably deleted from the BiB memory. In addition, all BiB-related call details may be deleted from logs. In Server based configuration, all generated keys and call details might be saved or deleted.

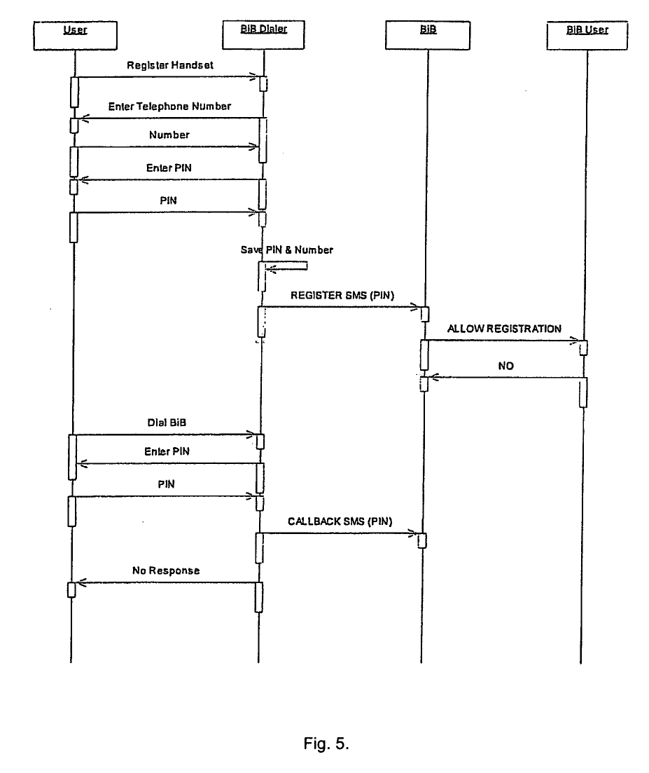

Referring now to FIG. 5, this is a sequence diagram showing how a BiB can decline a registration request from an unauthorised master originator.

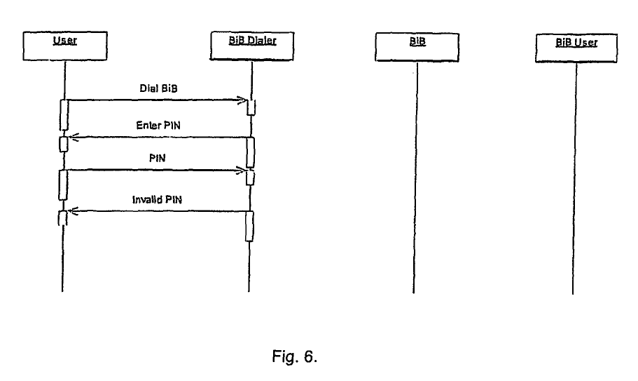

Referring now to FIG. 6, this is a sequence diagram showing how a BiB can decline access from a master originator when an incorrect PIN code is entered. No call need to be made to the BiB since the BiB master or access point phone checks the PIN with local records first. If the BiB fails to call back then a predetermined time limit (e.g. 2 minutes) is allocated during which the Originator will wait for the callback. After expire of the predetermined period, a waiting screen may be exited and a failure message may be displayed.

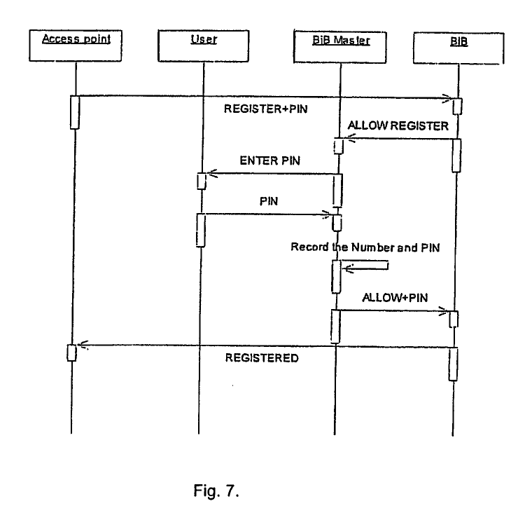

Referring now to FIG. 7, this is a sequence diagram showing how auxiliary originators can be registered with a BiB handset by way of the master originator.

Referring now to FIG. 8, when the Originator handset is dialing to BiB (1), it actually connects to the remote server at the same time (2), while its connection to the BiB is awaiting approval from the server. The remote server checks the BiB number that the Originator is trying to connect. The server may then request from the BiB to confirm its acceptance for this request (based on originator's ID or phone number) (3). Alternatively, the server may instead check to see if the Originator is allowed to connect to such a BiB within its own database. If it is allowed (4), the server then requests a Pin code from the Originator (5) if required. Upon authenticating the Originators ID (or phone number) and/or the Pin code (2, 3, 4 & 5 again), the software within the BiB handset accepts the call from the Originator and a connection is made (6). This is called SIP technique. The communication network for 3G or video call etc. is located on line (1) & (6).

Referring now to FIG. 9, the Originator contacts the BiB handset using 3G phone connection data (1). The BiB handset analysis the data and checks to see if this Originator is allowed to connect. If yes, the BiB then requests a Pin code (if necessary) (2). The Originator inputs the Pin code as it is send again by the 3G network data carrier (3). If the Pin code matches, then the connection is made (4). BiBs may be classified into a number of different use categories. They are similar within their design technology, except they might be in different shapes, and also they can have the options of limited or unlimited connection access. The categories are as follows:

| | |
|---|---|
| Baby-BiB: | in child care |
| R-BiB: | railway BiB |
| T-BiB: | traffic check |
| E-BiB: | employee survey BiB |
| H-BiB: | BiBs for hospitals, laboratories, conferences and research |
| | organisations |
| U-BiB: | universal BiB for sports, and public entertainment events |
| S-BiB: | security BiB for security check |

1. Baby-BiB: Child Care Check

Any parents who leave their child within nurseries or with nannies would like to see what exactly happens to their child whilst the child is away from them. They would be able to allocate a BiB to their child, “Baby-BiB”, which could be in the form of either a badge or a wristwatch. The parent may then simply contact that specific BiB at any time by using its pass code to connect automatically; and see how their child is and what is happening around them.

It is also possible with the BiB to record some voice or video clips, which may be sent to the parent's phone automatically. This facility is based on a preset-timer setting, or alternatively by a request from the originator in the form of a pre-determined message.

This particular product has endless possibilities and a large market as all parents would like to “keep an eye” on their child's environment when they are not around.

Nurseries or care providers may have initial reservations about the product as the parent will have unlimited access to viewing what happens throughout the day. However if the nursery was providing a good service to a proper standard of care they would have nothing to fear.

In fact the system could even be introduced by nurseries or childcare centres as an asset and an additional service that they are providing for parents. This would be an assurance to the parents that they are trustworthy and are caring for the children properly. This type of BiB could be installed within the nursery in specified locations such as a playroom, with the parents' phone numbers being registered on the BiB for them to connect and view their child at any time they wish.

2. R-BiB: Rail BiB

BiBs can be installed at level crossings to ensure that the track is clear on approach for trains. The train could be equipped with an originator in the form of a monitor which would have access to the BiBs on its route by way of a system of pass codes which would operate in sequence. For example, the Originator could be programmed to access the BiB at a chosen distance for example 1 km from the level crossing.

This system would save lives and save insurance companies millions of pounds, while the cost of a few phone connections during a journey can be easily recovered from the ticket sales.

3. T-BIB: Traffic BiB

BiBs can also be installed on the roads on traffic lights or lamp posts etc., to allow drivers to contact them at any time, to plan or check their travelling direction, at any time. These BiBs may be capable of allowing multi-unlimited connections.

The driver may not have access or the memory in his mobile to keep all the BiBs numbers within his mobile phone. If the driver knows the number, he can easily dial and connect to the BiB directly, while his phone has been defined for that BiB to accept the connection (this arrangement can be done at any time with a small extra fee on the membership). However this is the best opportunity for phone directory lines (referred here as 118xxx) that the originator can simply contact them, and seek to connect to BiBs in Street 1, Street 2, Street 3, etc. consequently, without a need to know the numbers for those BiBs. 118xxx directory can connect the originator sequentially within a specific time scale in between each connection. This time scale can be set up by the 118xxx operator at the time of inquiry, or the originator can skip from one to another by using options available within his mobile phone. This option will provide the best business opportunity for 118xxx directory industries, as it will allow us to arrange a profitable commission deal with them.

This facility will also allow the general public to check the weather in different towns or even countries by dialing the phone number of the allocated BiBs for this purpose in those places. Again the numbers for these BiBs can be accessible via 118xxx directories.

4. E-BIB: Employee Survey BiB

This will enable employers to check up on their businesses and to see live feedback on what is happening in real time. Again a central BiB could be installed in a specified location and only be accessed by the employer's pass code. This system would be particularly useful for employers who have premises on different sites.

5. H-BIB: BiBs for Hospitals, Labs, Conferences and Research organisations:

It is also possible to provide BiBs within any hospitals, laboratories or research organisations to allow anybody to view or listen to his patient who is critically ill in the hospital, and monitor his condition at any time, or view the surgery operation on his patient within the hospital. This will also allow a developer or the sponsor of a research project within a research organisation or lab to check the progress of the research at any time they wish. Again the BiB would be placed in a strategic position for ease of view to transfer the adequate data.

6. U-BIB: Universal BiB for Sport and Public entertainments:

This will allow the general public to connect and view any live sport or public entertainment activity via strategically placed BiBs. Access will be at a premium charge.

This is the only potential use of BiBs that is similar to the current 3G mobile phone technology; however, we will be producing a specific E-BiB that does not have any dialing capabilities for use in arenas whilst permitting the connection of an unlimited number of phones.

7. S-BIB: Home Security check:

This will allow to install a BiB in home or car or in a strategic place to check on that location remotely at any time.

It is also important that it is possible to equip BiB's with extra tools like movement sensors, heat detectors etc., that can be activated and can either record the data to send them later or send them live to one or more originator handsets.

1-31. (canceled)

32. A monitoring device for remotely monitoring an environment, said device comprising:
a radio communications unit;
a video camera adapted to be activated upon receipt of a predetermined communication from said radio communications unit and to transmit live video data from said video camera to said radio communications unit;
a microphone means adapted to transmit sound picked up by said microphone means to said radio communications unit together with the live video data from said video camera; and
an electronic computer means;
wherein said predetermined communication includes a caller identity of said remote radio communications unit and a security code, said security code being selected from the group consisting of alphabetical and alphanumeric PIN code.

33. The monitoring device as set forth in claim 32, wherein said video camera being adapted to transmit streaming video data.

34. The monitoring device as set forth in claim 32, wherein said electronic computer means is adapted by way of stored computer program means to activate said video camera and to transmit said video data only when said caller identity and/or said security code has been checked and found to be valid.

35. The monitoring device as set forth in claim 34, wherein said monitoring device is made resistant to tampering by requiring input of said security code in order to be deactivated.

36. The monitoring device as set forth in claim 35, wherein said monitoring device is adapted to contact said radio communications unit of its own accord without receiving said predetermined communication from said radio communications unit.

37. A monitoring system comprising:
at least one first device having a first radio communications unit, a video camera, electronic computer means, and microphone means; and
at least one second device having a second radio communications unit, video display means and electronic computer means;
wherein said first device is adapted, upon receipt of a predetermined communication from said second device, to activate said video camera and to transmit live video data from said video camera to said second radio communications device and to activate said microphone means and to transmit sound picked up by said microphone means to said second device together with said live video data;
wherein said second radio communications device is adapted to display said live video data on said video display means.

38. The monitoring system as set forth in claim 37, wherein said first device being adapted to transmit streaming video data.

39. The monitoring system as set forth in claim 38, wherein said predetermined communication includes a caller identity of said second device.

40. The monitoring system as set forth in claim 39, wherein said predetermined communication includes a security-code.

41. The monitoring system as set forth in claim 40, wherein said electronic computer means of said first device is adapted by way of stored computer program means to activate said video camera and to transmit video data only when said caller identity and/or said security code has been checked and found to be valid.

42. The monitoring system as set forth in claim 41, wherein said first device is made resistant to tampering by requiring input of a security code in order to be deactivated.

43. The monitoring system as set forth in claim 42, wherein said first device is adapted to contact said second device of its own accord without receiving said predetermined communication from said second device.

44. The monitoring system as set forth in claim 43, wherein said second device consists of one second device configured as a master second device, and at least one further second device that is assignable to said first device by way of said master second device.

45. The monitoring system as set forth in claim 44, wherein said first and second devices identify each other and authorize mutual communication by way of a remote server.

46. The monitoring system as set forth in claim 45, wherein said first and second device comprises a unit adapted for standard mobile telephone transmissions under a protocol selected from the group consisting of GSM and 3G protocol.

47. The monitoring system as set forth in claim 46, wherein said first and/or second device dialing and/or ringing capabilities are adapted to be automatically disabled by way of key locks and/or muting.

48. A method of using a monitoring system comprising the steps of:
providing a monitoring system comprising: at least one first device having a first radio communications unit, a video camera, electronic computer means, and microphone means; and at least one second device having a second radio communications unit, video display means and electronic computer means;
contacting said first device via said second device to produce a connection;
requesting an access right from said first device;
determining if said first device has limited access, if the access is limited then determining if said connection is within a limited number of connections in said first device, if said connection is not within said limited number of connections then said connection is terminate;
determining if said second device is recognizable by said first device, if said second device is not recognized by said first device then said connection is terminated;
determining if said first device requires a security-code, if said first device does not require a security-code then said connection is established;
requesting said security-code from said second device; and
establishing said connection to said first device.

49. The method as set forth in claim 48, wherein said first and second devices are mobile telephones, and said security-cod being a password that is only valid for said second device's mobile phone number.

50. The method as set forth in claim 49 further comprising the steps of inputting information and specifying operations through a unit operation section, performing communications between said first device and said second device through a data transmitter-receiver, creating said password through a password creating unit, outputting current time information from a time keeping unit, and recording a terminal-unique information given to a mobile terminal through a unit-unique-information recoding unit.

51. The method as set forth in claim 50, wherein said password is valid only for a limited period of time.
